(19) United States
(12) Patent Application Publication
(10) Pub. No.: US 2018/0170750 A1
(43) Pub. Date: Jun. 21, 2018

(54) MILLIMETER-SCALE EXCHANGER-REACTOR FOR HYDROGEN PRODUCTION OF LESS THAN 10 Nm3/h

(71) Applicant: L'Air Liquide, Société Anonyme pour I'Etude et I'Exploitation des Procés Georges Claude, Paris (FR)

(72) Inventors: Pascal DEL-GALLO, Dourdan (FR); Olivier DUBET, Buc (FR); Matthieu FLIN, Vanves (FR); Laurent PROST, Gif-sur-Yvette (FR); Marc WAGNER, Saint-Mur-des-Fossés (FR)

(21) Appl. No.: 15/550,618

(22) PCT Filed: Feb. 3, 2016
(86) PCT No.: PCT/FR2016/050229

§ 371 Date: Jan. 2, 2018

(30) Foreign Application Priority Data
Feb. 12, 2015 (FR) 1551140

(51) Int. Cl. C01B 3/38; B01J 15/00; B01J 19/24; B22F 5/10; B33Y 80/00; F28F 9/02

(52) U.S. Cl. CPC C01B 3/384; B01J 15/005; B01J 19/249; B22F 5/106; B33Y 80/00; B22F 3/1055; C01B 2203/0233; C01B 2203/0833; C01B 2203/066; B01J 2219/00081; F28F 9/0224

(57) ABSTRACT

Reactor-exchanger comprising at least 3 stages with, on each stage, at least one area promoting the heat exchanges and at least one distribution area upstream and/or downstream of the area promoting the heat exchanges, characterized in that the area promoting the heat exchanges comprises cylindrical millimetric channels, there being 1 to 1000 of said channels with a length of between 10 mm and 500 mm.

The present invention relates to millimetre-scale reactors-exchangers, to their manufacturing method and to their use.

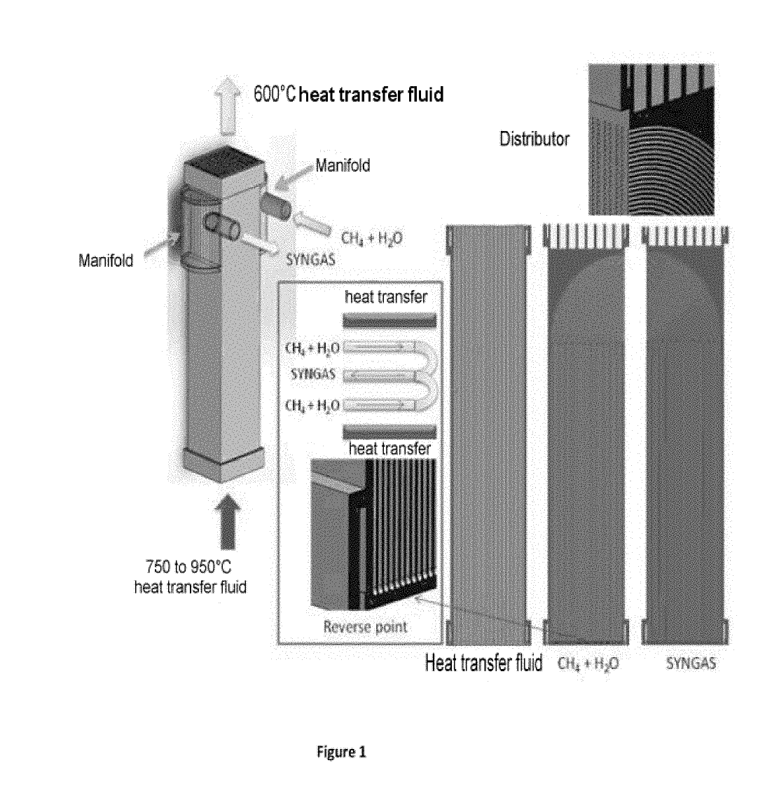

A millimetre-scale exchanger-reactor is a chemical reactor in which the exchanges of material and of heat are intensified through a geometry of channels whose characteristic dimensions such as the hydraulic diameter are of the order of a millimetre. These millimetre-scale exchangers-reactors make it possible also to develop significant exchange surfaces in a reduced volume, which makes them compact. The channels that make up the geometry of the millimetre-scale exchangers-reactors are of cylindrical form, this form is obtained by the production of this pressure vessel by additive manufacturing under a powder bed or by powder spraying. The terms: (i) “stage” should be understood to be a set of channels positioned on one and the same level and in which a chemical reaction and/or a heat exchange takes place, (ii) “wall” should be understood to be a separating partition between two consecutive channels arranged on one and the same level, (iii) “distributor” or “distribution area” should be understood to mean a volume linked to a set of channels and arranged on one and the same stage or a set of channels, the purpose of which is to route, to the channels, the gas coming from the manifolds and entering into the exchanger-reactor or to route, to the manifold, the gas leaving the exchanger-reactor, (iv) “manifold” should be understood to be a volume linked to a set of channels and arranged on one and the same stage and in which circulates either the reagents routed from outside of the exchanger-reactor to a set of channels, or the products of the reaction routed from the set of channels to the outside of the exchanger-reactor (FIG. 1). The operation of the exchanger-reactor is defined in FIG. 1, the manifolds supply and discharge the gases; at the input, the hydrocarbon charge-steam mixture and at the output the synthesized gas produced. The heat transfer fluid at between 750 and 950° C. adds heat to the system to produce the steam reforming of a hydrocarbon charge. Three types of stage can be distinguished according to the fluid circulating in the channels of this stage:
the stages comprising so-called “reagent” channels in which circulates, generally, in the case of steam reforming, a hydrocarbon charge and steam mixture,
the stages comprising so-called “return” channels in which circulate the products of the steam reforming reaction. The products of the steam reforming reaction give to the hydrocarbon charge-steam mixture a part of the heat necessary to the steam reforming reaction,
the stages comprising so-called “heat top up” channels in which circulates a heat transfer fluid making it possible to add the heat necessary to the steam reforming reaction.

An exchanger-reactor is made up of the stacking of these three types of stages.

The thermal integration of these apparatuses can be the subject of in-depth optimizations making it possible to optimize the heat exchanges between the fluids circulating in the apparatus at different temperatures by virtue of a spatial distribution of the fluids over several stages and the use of several distributors and manifolds. To fully exploit the benefits of the use of a millimetre-scale exchanger-reactor or of a millimetre-scale exchanger in the industrial methods targeted, such equipment must have the following properties:
the possibility of being able to work at a high pressure x temperature product whose minimum values are general of the order of 12 000 bar.° C. (corresponding to a minimum temperature of 600° C. and a minimum pressure of 1 bar up to more than 20 bar.)
an extremely high value of the surface/volume ratio whose typical values lie between 40 000 and 700 m²/m³ and which allows the intensification of the phenomena at the walls and in particular the heat transfer for the exchange of heat and the material transfer for the reaction in the case of an exchanger-reactor. Moreover, these very high values of the surface to volume ratio make it possible to develop a considerable exchange surface with a reduced equipment bulk, compared to competing technologies (tubes and calenders, etc.).

Several equipment manufacturers offer millimetre-scale exchangers-reactors, most of these apparatuses are made up of plates consisting of channels which are obtained by chemical machining by spraying or immersion. This manufacturing method results in channels being obtained whose section has a form which approximates to a half-circle and whose dimensions are approximate and difficult to reproduce from one manufacturing batch to another because of the machining method itself. In effect, in the chemical machining operation, the bath used is polluted by the metal particles torn from the plates and although the latter is regenerated, it is difficult, for reasons of operation cost, to maintain the same efficiency when manufacturing a large series of plates. Hereinbelow, “semi-circular section” will be understood to mean the section of a channel whose properties suffer from the dimensional limits described previously and induced by manufacturing methods such as chemical etching and stamping.

Even if this channel manufacturing method is of no interest from an economical point of view, it is possible to imagine the channels that make up the plates being manufactured by traditional machining. In this case, the section of the latter would not be of semi-circular type but rectangular, then described as “rectangular section”.

The plates made up of channels of semi-circular or right-angled sections thus obtained are generally assembled together by diffusion welding or diffusion brazing.

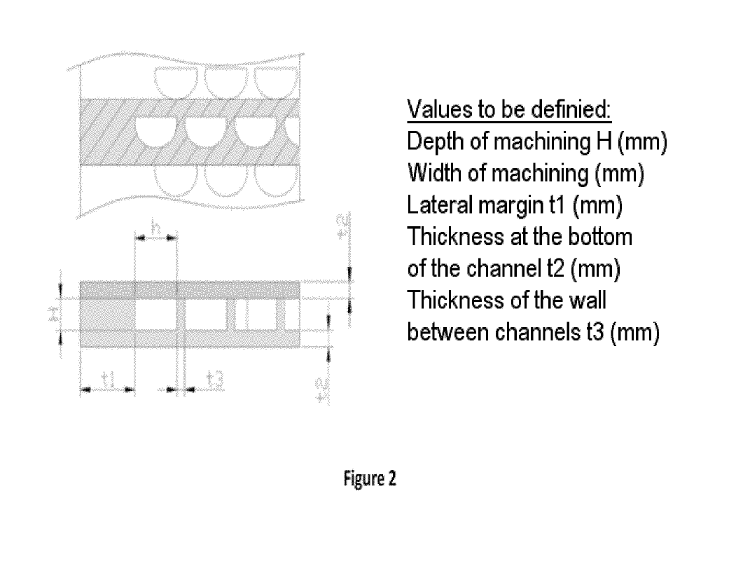

The dimensioning of these semi-circular or rectangular section apparatuses is based on the application of ASME (American Society of Mechanical Engineers) section VIII div.1 appendix 13.9 which incorporates the mechanical design of a millimetre-scale exchanger and/or exchanger-reactor consisting of etched plates. The values to be defined to obtain the desired mechanical strength are indicated in FIG. 2. The dimensioning of the distribution area and of the manifold, of variable geometry (walls and channel widths), is done by finite elements computation because the ASME code does not provide the analytical dimensioning of these areas.

Once the dimensioning is established, the regulatory validation of the design, defined by this method, requires a burst test according to ASME UG 101. For example, the burst value expected for an exchanger-reactor assembled by diffusion brazing and made of Inconel alloy (HR 120) operating at 25 bar and at 900° C. is of the order of 3500 bar at ambient temperature. This is extremely disadvantageous because this test requires the reactor to be overdimensioned in order to conform to the burst test at ambient temperature, the reactor thus losing its compactness and its efficiency in terms of heat transfer due to the augmentation of the walls of the channels.

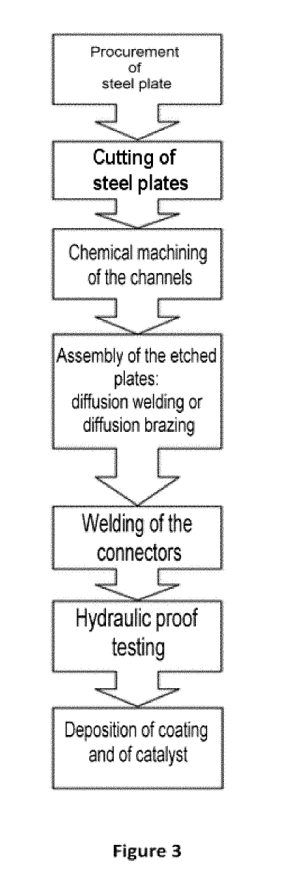

The manufacturing of these millimetre-scale exchangers-reactors and/or exchangers is currently performed according to the seven steps described by FIG. 3. Of these steps, four are critical because they can create problems of nonconformity for which the only outcome is to scrap the exchanger or the exchangers-reactors or plates that make up the pressure apparatus if this nonconformity is detected sufficiently early in the production line of these apparatuses.

These four steps are:
chemical machining of the channels,
assembly of the etched plates by diffusion brazing or diffusion welding,
welding of the connection heads, on which welded tubes supply or discharge fluids, to the distribution areas and the manifolds, and finally,
the operations of deposition of protective coatings and of catalyst in the case of an exchanger-reactor or of an exchanger subject to a use inducing phenomena which can degrade the surface condition of the apparatus.

Whatever the machining method used to manufacture the millimetre-scale exchanger or exchanger-reactors, channels are obtained of semi-circular section in the case of the chemical machining (FIG. 1) and which are made up of two right angles or of rectangular section in the case of the traditional machining and which are made up of four right angles. This plurality of angles is prejudicial to obtaining a uniform protective coating over all the section. In effect, the phenomena of geometrical discontinuities such as angles increase the probability of generating non-uniform depositions, which will inevitably lead to the initiation of phenomena of degradation of the surface condition of the die that has to be guarded against such as, for example, phenomena of corrosion, of carburation or of nitriding.

The angular channel sections obtained by the chemical machining or traditional machining techniques do not make it possible to optimize the mechanical strength of such an assembly. In effect, the calculations for dimensioning such sections for pressure withstand strength result in an increase in the thickness of the channel walls and the bottom, the equipment thus losing its compactness but also its efficiency in terms of heat transfer.

Furthermore, the chemical machining imposes limitations in terms of geometrical forms such that it is not possible to have a channel having a height greater than or equal to its width, which leads to limitations of the surface/volume ratio resulting in optimization limitations.

The assembly of the etched plates by diffusion welding is obtained by the application of a high uni-axial strain (typically of the order of 2 to 5 MPa) on the die consisting of a stacking of etched plates and exerted by a high-temperature press for a holding time of several hours. The implementation of this technique is compatible with the manufacturing of apparatuses of small dimensions such as for example apparatuses contained in a volume 400 mm×600 mm. Beyond these dimensions, the force to be applied to maintain a constant strain becomes too high to be implemented by a high-temperature press.

Some manufacturers using the diffusion welding method mitigate the difficulties of implementation of a high strain by the use of a so-called self-clamping rig. This technique does not make it possible to effectively control the strain applied to the equipment which results in channels being crushed.

The assembly of the etched plates by diffusion brazing is obtained by the application of a low uni-axial strain (typically of the order of 0.2 MPa) exerted by a press or a self-clamping rig at high temperature and for a holding time of several hours with the die made up of the etched plates. Between each of the plates, a brazing filler metal is deposited according to industrial deposition methods which do not make it possible to guarantee the perfect control of this deposition. The purpose of this filler metal is to diffuse in the die during the brazing operation so as to produce the mechanical join between the plates.

Furthermore, while the equipment is being held at temperature during manufacturing, the diffusion of the brazing metal cannot be controlled, which can lead to discontinuous brazed joints resulting in a degradation of the mechanical withstand strength of the equipment. As an example, the equipment manufactured according to the diffusion brazing method and dimensioned according to ASME section VIII div.1 appendix 13.9 in HR120 that we have produced did not withstand the application of a pressure of 840 bar during the burst test. To mitigate this degradation, the thickness of the walls and the geometry of the distribution area were adapted in order to increase the contact surface between each plate. This causes the surface/volume ratio to be limited, the head loss to be increased and poor distribution in the channels of the equipment.

Furthermore, the ASME code section VIII div.1 appendix 13.9 used for the dimensioning of this type of brazed equipment does not allow the use of the diffusion brazing technology for equipment implementing fluids containing a lethal gas such as carbon monoxide for example. Thus, an apparatus assembled by diffusion brazing cannot be used for the production of Syngas.

The equipment manufactured by diffusion brazing ultimately consists of a stacking of etched plates between which brazed joints are arranged. Because of this, any welding operation on the faces of this equipment leads in most cases to the destruction of the brazed joints in the area affected thermally by the welding operation. This phenomenon is propagated along the brazed joints and leads in most cases to the rupture of the assembly. To mitigate this problem, it is sometimes proposed to add thick reinforcing plates at the time of assembly of the brazed die so as to offer a support of frame type for the welding of the connectors which has no brazed joint.

From a method intensification point of view, the assembling together of the etched plates means that the equipment has to be designed with a two-dimensional approach which limits the thermal and fluidic optimization in the exchanger or exchanger-reactor by requiring the designers of this type of equipment to limit themselves to a fluid distribution stage approach.

From an eco-manufacturing point of view, all these manufacturing steps being carried out by different trades are generally performed by various subcontractors located at different geographic locations. This causes lengthy production delays and numerous part transportations. Starting from there, one problem which arises is how to provide an improved reactor-exchanger that does not have at least some of the drawbacks cited above.

One solution of the present invention is a reactor-exchanger comprising at least 3 stages with, on each stage, at least one area promoting the heat exchanges and at least one distribution area upstream and/or downstream of the area promoting the heat exchanges, characterized in that the area promoting the heat exchanges comprises cylindrical millimetric channels, there being 1 to 1000 of said channels with a length of between 10 mm and 500 mm.

Depending on the case, the reactor-exchanger according to the invention can have one or more of the following features:
the distribution area comprises millimetric channels which correspond to the continuous extension of the channels of the area promoting the heat exchanges,
the channels of one and the same stage are separated by walls with a thickness of less than 2 mm,
the channels have a hydraulic diameter of between 0.5 and 3 mm,
the channels have a length of between 50 and 400 mm, preferably between 100 and 300 mm,
said exchanger-reactor comprises a “reaction” stage whose channels are capable of promoting a reaction by notably allowing the circulation of reagent gaseous flows, a “return” stage whose channels allow the circulation of product gaseous flows, a “heat top up” stage whose channels allow the circulation of a heat transfer fluid.
the number of channels at the “reaction” stage is between 100 and 700, preferably between 200 and 500,
the number of channels at the “return” stage is between 100 and 700, preferably between 200 and 500,
the number of channels at the “heat top up” stage is between 100 and 700, preferably between 200 and 500,
the “reaction” stage is surrounded by a “heat top up” level and a “return” level,
the channels of the “reaction” stage and the channels of the “return” stage have, over at least a part of their internal walls, a protective coating against corrosion,
the channels of the “reaction” stage have, over at least a part of their internal walls, a catalyst.

Note that the protective coating and the catalyst are preferably deposited by liquid means. Another subject of the present invention is the manufacturing of the reactor-exchanger according to the invention. An additive manufacturing method is preferably used to manufacture a reactor-exchanger according to the invention. Preferably, the additive manufacturing method implements, as base material, at least one metal powder of micrometric size.

The additive manufacturing method can implement metal powders of micrometric size which are melted by one or more lasers in order to manufacture finished parts of complex forms in three dimensions. The part is constructed layer by layer, the layers are of the order of 50 μm, depending on the accuracy of the forms required and the desired rate of deposition. The metal to be melted can be provided either by powder bed or by a spray nozzle. The lasers used to locally melt the powder are either YAG, fibre or CO2 lasers and the melting of the powders is performed under inert gas (argon, helium, etc.). The present invention is not limited to a single additive manufacturing technique but it applies to all the known techniques.

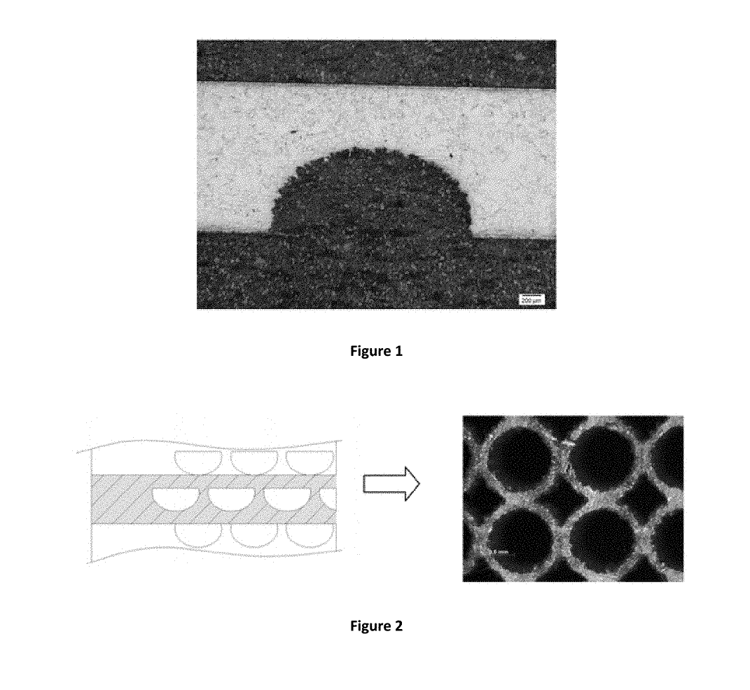

Unlike chemical machining or traditional machining techniques, the additive manufacturing method makes it possible to produce channels of cylindrical section with the following advantages (FIG. 4): (i) of offering a better pressure withstand strength and thus allowing a significant reduction of the thickness of the walls of the channels and (ii) of allowing the use of pressure apparatus dimensioning rules which do not require the performance of a burst test to prove the efficiency of the design as is the case for section VIII div.1 appendix 13.9 of the ASME code.

In effect, the design of an exchanger or of an exchanger-reactor produced by additive manufacturing, making it possible to produce channels with cylindrical section (FIG. 5), relies on “standard” pressure apparatus dimensioning rules which are applied to the dimensioning of the channels, of the distributors and of the manifolds with cylindrical sections that make up the millimetre-scale exchanger-reactor or exchanger. As an example, the dimensioning of the wall of straight channels with rectangular section (value t₃ on FIG. 2) of a reactor-exchanger made of nickel alloy (HR 120), dimensioned according to the ASME (American Society of Mechanical Engineers) section VIII div.1 appendix 13.9, is 1.2 mm. By using channels with cylindrical section, this wall value calculated by the ASME section VIII div.1 is no more than 0.3 mm, i.e. a fourfold reduction of the wall thickness necessary for the pressure withstand strength.

The reduction of the volume of material associated with this gain makes it possible (i) either to reduce the bulk of the apparatus with identical production capacity by the fact that the number of channels necessary to achieve the targeted production capacity is lesser and thus occupies less space, (ii) or to increase the production capacity of the apparatus by retaining the bulk thereof which makes it possible to position more channels and thus handle a greater flow rate of reagents.

Furthermore, in the case of millimetre-scale exchanger-reactor or exchanger produced in noble alloy with a strong nickel charge, the reduction of material needed is in line with an eco-design beneficial to the environment while reducing the cost in raw materials.

The additive manufacturing techniques ultimately make it possible to obtain so-called “bulk” parts, which, contrary to the assembly techniques such as diffusion brazing or diffusion welding, have no assembly interfaces between each etched plate. This property supports the mechanical withstand strength of the apparatus by eliminating, by construction, the presence of embrittlement lines and by thereby eliminating a potential source of defect.

The obtaining of bulk parts by additive manufacturing and the elimination of the diffusion brazing or welding interfaces makes it possible to envisage numerous design possibilities without being limited to wall geometries designed to limit the impact of any assembly faults such as discontinuities in the brazed joints or in the welded-diffused interfaces.

Additive manufacturing makes it possible to produce forms that cannot be envisaged by the traditional manufacturing methods and thus the manufacturing of the connectors of the millimetre-scale exchangers-reactors or exchangers can be done in continuity with the manufacturing of the body of the apparatuses. This then makes it possible to not perform an operation of welding of the connectors to the body and thus eliminate a source of damage to the structural integrity of the equipment.

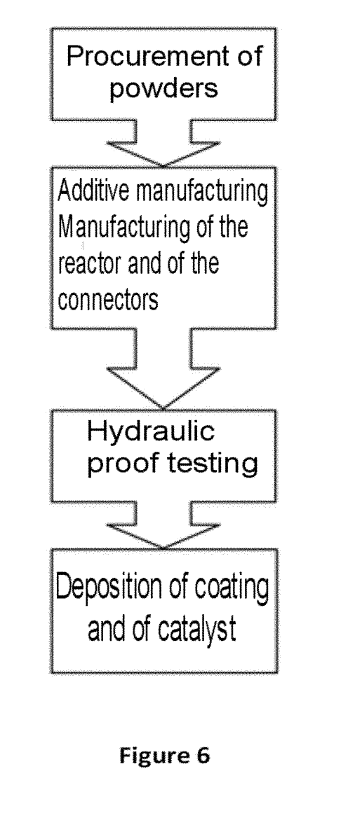

The control of the geometry of the channels by additive manufacturing allows the production of channels with circular section which, in addition to the good pressure withstand strength that this form provides, makes it possible also to have a channel form that is optimal for the deposition of protective coatings and of catalysts which are thus uniform all along the channels. By using this additive manufacturing technology, the productivity gain aspect is also made possible by the reduction of the number of manufacturing steps. In effect, the steps of producing a reactor by incorporating additive manufacturing change from seven to four (FIG. 6). The critical steps, potentially resulting in a scrapping of a complete apparatus or of the plates forming the reactor, of which there are four when using the conventional manufacturing technique by assembly of chemically etched plates, change to two with the adoption of additive manufacturing. Thus, the only remaining steps are the additive manufacturing step and the step of deposition of coatings and of catalysts.

To sum up, the advantages of additive manufacturing over a conventional solution of diffusion brazing or welding of chemically etched plates are:
a greater intensification of the method (integration of the channels, compactness)
a reduction of the weight of the reactor or increase in the volume useful to the catalytic reaction
a reduction of the number of manufacturing steps and of parties involved located on different sites
improved manufacturing quality by ensuring perfect reproducibility
possible monitoring of the method during manufacturing, which will reduce the quantity of parts scrapped
simplification of the design validation according to the ASME construction code.

The exchanger-reactor according to the invention is particularly suitable for use in a steam reforming method, preferably for the production of hydrogen with a flow rate of between 0.1 and 10 Nm³/h, preferably between 1 and 5 Nm³/h.

In the context of hydrogen production less than 5 Nm³/h, we can take the example of an exchanger-reactor made of Inconel 625 for the production of 0.6 Nm³/h of hydrogen intended to supply a fuel cell to produce electricity and hot water in a dwelling. The dimensional characteristics for this reactor-exchanger would be as follows:
Nickel-based materials (Inconel 601-625-617-690)
Channels 1.14 mm in diameter
0.4 mm wall
Effective length of the channels 150 mm
Number of “reagent” channels 232
Number of “return” channels 116
Number of “heat top up” channels 174
Width of the exchanger-reactor 49 mm
Overall length of the exchanger-reactor 202 mm
Height of the exchanger-reactor 25.4 mm
The “reagent” channels and the “return” channels are protection coated against corrosion
The “reagent” channels are coated with catalyst

From the following input conditions:

| | | Reagent gas | Fumes |
|---|---|---|---|
| Flow rate | Nm³/h | 0.70 | 2.01 |
| Temperature | ° C. | 368.5 | 900 |
| Pressure | bar | 1.1 | 1.1 |
| Composition | CH₄ | 0.2050 | 0.0000 |
| | C2 | 0.0000 | 0.0000 |
| | H₂O | 0.6149 | 0.1149 |
| | O₂ | 0.0000 | |
| | CO₂ | 0.0439 | 0.0307 |
| | H₂ | 0.1357 | 0.0000 |
| | CO | 0.0005 | 0.0000 |
| | N₂ | 0.0000 | 0.7213 |

The equipment described previously makes it possible to achieve the following performance levels:

| | | Gas produced | Fumes |
|---|---|---|---|
| Flow rate | Nm³/h | 0.97 | 2.01 |
| Temperature | ° C. | 439 | 460 |
| Pressure | bar | 1.1 | 1.1 |
| Composition (mol basis) | CH₄ | 0.01 | 0.0000 |
| | C2 | 0.0000 | 0.0000 |
| | H₂O | 0.31 | 0.1149 |
| | O₂ | 0.0000 | 0.1331 |
| | CO₂ | 0.030 | 0.0307 |
| | H₂ | 0.51 | 0.0000 |
| | CO | 0.14 | 0.0000 |
| | N₂ | 0.0000 | 0.7213 |
| Head loss | mbar | 6.19 | 10.76 |

1.-16. (canceled)

17. A reactor-exchanger comprising at least 3 stages with, on each stage, at least one area promoting heat exchange and at least one distribution area upstream and/or downstream of the area promoting the heat exchanges, wherein the area promoting heat exchange comprises cylindrical millimetric channels, wherein there are between 1 and about 1000 of said channels, each channel comprising a length of between about 10 mm and about 500 mm.

18. The reactor-exchanger according to claim 17, wherein the at least one distribution area comprises cylindrical millimetric channels which correspond to a continuous extension of the channels of the area promoting heat exchange.

19. The reactor-exchanger according claim 17, wherein the cylindrical millimetric channels the same stage are separated by walls with a thickness of less than 2 mm.

20. The reactor-exchanger according to claim 17, wherein the cylindrical millimetric channels have a hydraulic diameter of between about 0.5 and about 3 mm.

21. The reactor-exchanger according to claim 17, wherein the cylindrical millimetric channels have a length of between about 50 and about 400 mm.

22. The reactor-exchanger according to claim 17, wherein said exchanger-reactor comprises:
a “reaction” stage whose channels are configured to promote a reaction by allowing the circulation of a reagent gaseous flow,
a “return” stage whose channels are configured to allow the circulation of a product gaseous flow,
a “heat top up” stage whose channels are configured to allow the circulation of a heat-transfer fluid.

23. The reactor-exchanger according to claim 22, wherein the number of channels at the “reaction” stage is between about 100 and about 700.

24. The reactor-exchanger according to claim 22, wherein the number of channels at the “return” stage is between about 100 and about 700.

25. The reactor-exchanger according to claim 22, wherein the number of channels at the “heat top up” stage is between about 100 and about 700.

26. The reactor-exchanger according to claim 22, wherein the “reaction” stage is surrounded by a “heat top up” level and a “return” level.

27. The reactor-exchanger according to claim 22, wherein the channels of the “reaction” stage and the channels of the “return” stage have, over at least a part of their internal walls, a protective coating against corrosion.

28. The reactor-exchanger according to claim 22, wherein the channels of the “reaction” stage have, over at least a part of their internal walls, a catalyst.

29. A method for steam reforming a hydrocarbon charge implementing a reactor-exchanger according to claim 17.

30. The steam-reforming method according to claim 29, comprising a production of hydrogen exhibiting a flow rate of between 0.1 and 10 Nm³/h.
